(19) United States
(12) Patent Application Publication
(10) Pub. No.: US 2007/0088516 A1
(43) Pub. Date: Apr. 19, 2007

(54) Low bandwidth reduced reference video quality measurement method and apparatus

(76) Inventors: Stephen Wolf, Longmont, CO (US); Margaret H. Pinson, Boulder, CO (US)

Correspondence Address: ROBERT PLATT BELL;REGISTERED PATENT ATTORNEY, P.O. BOX 13165, JEKYLL ISLAND, GA, 31527, US

(21) Appl. No.: 11/545,801

(22) Filed: Oct. 10, 2006

Related U.S. Application Data
(60) Provisional application No. 60/726,923, filed on Oct. 14, 2005.

(51) Int. Cl. G01N 37/00

(52) U.S. Cl. 702/81

(57) ABSTRACT

A new reduced reference (RR) video calibration and quality monitoring system utilizes less than 10 kilobits/second of reference information from the source video stream. This new video calibration and quality monitoring system utilizes feature extraction techniques similar to those found in the NTIA General Video Quality Model (VQM) recently standardized by the American National Standards Institute (ANSI) and the International Telecommunication Union (ITU). Objective to subjective correlation results are presented for 18 subjectively rated data sets that include more than 2500 video clips from a wide range of video scenes and systems. The method is being implemented in a new end-to-end video-quality monitoring tool that utilizes the Internet to communicate the low bandwidth features between the source and destination ends.

### CROSS-REFERENCE TO RELATED APPLICATIONS

The present application claims priority from Provisional U.S. Patent Application Ser. No. 60/726,923, filed Oct. 14, 2005 and incorporated herein by reference in its entirety.

### FIELD OF THE INVENTION

The present invention relates to a reduced reference method of estimating video system calibration and quality. In particular, the present invention is directed toward a new, low bandwidth realization of the reduced reference method of estimating video system calibration and quality.

### BACKGROUND OF THE INVENTION

The present invention comprises a new, low bandwidth realization of earlier inventions by the present inventors and their colleagues. The following patents disclose the earlier inventions; U.S. Pat. No. 5,446,492 issued Aug. 29, 1995 entitled “Perception-Based Video Quality Measurement System,” Stephen Wolf, Stephen Voran, Arthur Webster; U.S. Pat. No. 5,596,364 issued Jan. 21, 1997 entitled “Perception-Based Audio-Visual Synchronization Measurement System,” Stephen Wolf. Robert Kubichek, Stephen Voran, Coleen Jones, Arthur Webster, Margaret Pinson; and U.S. Pat. No. 6,496,221 issued Dec. 17, 2002 entitled “In-Service Video Quality Measurement System Utilizing an Arbitrary Bandwidth Ancillary Data Channel,” Stephen Wolf and Margaret H. Pinson, all of which are incorporated herein by reference.

The above-cited Patents disclose a reduced reference method of estimating video system calibration and quality. Features are extracted from the original video signal and from the same signal after it has been transmitted and received, send over a network, compressed, recorded and played back, or stored and recovered. The Mean Opinion Score (MOS) that human views would give to the processed video are determined from differences between the features from the original and the processed video. Thus, the invention is useful for determining how well equipment maintains the quality of video and the quality of video that a user receives.

Other references also relevant to the present invention include the following papers, all of which are incorporated herein by reference:
Reduced Reference Video Calibration Algorithms, National Telecommunications and Information Administration (NTIA) Technical Report TR-06-433a, July, 2006. www.its.bldrdoc.gov/n3/video/documents.htm
In Service Video Quality Metric (IVQM) User's Manual, National Telecommunications and Information Administration (NTIA) Handbook HB-06-434a, July, 2006.
“Video Quality Measurement Techniques,” NTIA Report 02-392, June 2002. www.its.bldrdoc.gov/n3/video/documents.htm
M. Pinson and S. Wolf. “A New Standardized Method for Objectively Measuring Video Quality,” IEEE Transactions on Broadcasting, v. 50, n. 3, pp. 312-322, September, 2004. www.its.bldrdoc.gov/n3/video/documents.htm
“Final Report from the Video Quality Experts Group on the Validation of Objective Models of Video Quality Assessment, Phase II,” Video Quality Experts Group, August 2003. www.its.bldrdoc.gov/dist/ituvidg/frtv2 final report
ANSI TI.801-2003, “Digital Transport of One-Way Video Signals—Parameters for Objective Performance Assessment,” American National Standards Institute, approved September 2003.
ITU-T J.144R, “Objective Perceptual Video Quality Measurement Techniques for Digital Cable Television in the Presence of a Full Reference,” Telecommunication Standardization Sector, approved March 2004.
ITU-R BT.1683, “Objective Perceptual Video Quality Measurement Techniques for Standard Definition Digital Broadcast Television in the Presence of a Full Reference,” Radiocommunication Sector, approved June 2004.
S. Wolf and M. H. Pinson, “The Relationship Between Performance and Spatial-Temporal Region Size for Reduced-Reference, In-Service Video Quality Monitoring Systems,” SCI/ISAS 200 I (Systematics, Cybernetics, and Informatics/Information Systems Analysis and Synthesis), July 2001. www.its.bldrdoc.gov/n3/video/documents.htm
M. Pinson and S. Wolf, “An Objective Method for Combining Multiple Subjective Data Sets,” SPIE Video Communications and Image Processing Conference, Lugano, Switzerland, July 2003. www.its.bldrdoc.gov/n3/video/documents.htm

### SUMMARY OF THE INVENTION

The present invention differs from the previously cited earlier inventions as follows. The present invention may use only a data bandwidth of 10 kilobits/sec or less to communicate the features extracted from standard definition video to the location where they are compared. A recent embodiment of the invention set forth in U.S. Pat. No. 6,496,221, previously cited and incorporated by reference, called the “General Model”, was standardized by American National Standards Institute (ANSI) as ANSI TI.801.03-2003 and by the ITU in ITU-T Recommendation J.144R and ITU-R Recommendation BT.1683. However, the General Model requires a data bandwidth of several Megabits/sec to operate on standard definition image sizes (e.g., 720×480 pixels). The new invention achieves similar performance to the General Model but only requires 10 kilobits/sec, making it easier to transmit such data over networks of limited bandwidth. In addition, the present invention can optionally utilize a second set of low bandwidth features (e.g., 20 kilobits/sec) to perform video system calibration (i.e., gain, level offset, spatial scaling/registration, valid video region, estimation, and temporal registration) of the destination video stream with respect to the source video stream. These low bandwidth calibration features may be configured for downstream (from source to destination) or upstream (from destination to source) quality monitoring configurations. The General Model requires full access to the video pixels of both the source and destination video streams to achieve equivalent video system calibration accuracy, and this requires several hundreds of Megabits/sec. Thus, the present invention is much more suitable for performing end-to-end in-service video system calibration and quality monitoring than the General Model.

The present invention may use three of the same features used by the General Model, ƒ_{SI13}, ƒ_{HV13}, and ƒ_{COHER}_{_{—}}_{COLOR} but these features are extracted from much larger spatial-temporal regions of the source and destination video streams. In addition, the present invention may adapt the filter size that is utilized for the computation of the ƒ_{SI} and ƒ_{HV} spatial resolution features (e.g., the present invention may utilize 5×5, 9×9, 21×21 filter sizes in addition to the 13×13 filter size that is used in the General Model). This adaptability depends upon the video image size and viewing distance and enables the present invention to produce more accurate quality estimates for low resolution video systems (e.g., 176×144 pixels as used in cell phones) and high resolution video systems (e.g., 1920×1080 pixels as used in high definition TV, or HDTV). This present invention also uses a newly developed feature called ƒ_{ATI} that is an improvement on the absolute frame-differencing filter feature described in U.S. Pat. No. 5,446,492, previously cited and incorporated by reference. This feature measures the Absolute Temporal Information (ATI), or motion, in all three image planes.

The present invention may use a non-linear 9-bit quantizer not used in the earlier inventions. This non-linear quantizer design maximizes the performance of the invention (i.e., how closely the invention's quality estimates are highly correlated with MOS) while minimizing the number of bits that are required for coding a given feature.

The present invention may use special processing applied to the feature ƒ_{ATI} that has not been used in the earlier inventions. The special processing enhances the performance of the feature for quantifying the perception aspects of noise and errors in the digital transmission while minimizing the sensitivity to dropped video frames (which are adequately quantified by the other features).

The present invention may use two new error-pooling methods in combination for comparing destination features with source features. One is the macro-block error pooling function and the other is a generalized Minkowski (P,R) error pooling function. The macro-block error pooling function enables the invention to be sensitive to localized spatial-temporal impairments (e.g., worse case processing within a macro-block, or localized group of features) while preserving robustness of the overall video quality estimate. The Minkowski error pooling function has been used in video quality measurement methods before, but only with P=R. In the generalized Minkowski summation used in the present invention P does not have to equal R and this produces an improved linear response of the invention's output to MOS.

The present invention includes a new algorithm to detect video systems that spatially scale (i.e., stretch or compress) video sequences. While uncommon in TV systems, spatial scaling is now commonly found in new Multimedia video systems.

The present invention may also use a new spatial registration algorithm (i.e., method to spatially register the destination video to the source video) suited to a low feature transmission bandwidth operating environment. This algorithm requires only 0.2% of the bandwidth required by the “General Model” while achieving similar performance.

The present invention includes modifications to other video calibration and quality estimation procedures that significantly reduce both feature transmission bandwidth and computations with a minimal impact on video quality estimation accuracy. For example, a sequence of contiguous images (e.g., 30) can be optionally pre-averaged before computation of the ƒ_{SI} and ƒ_{HV} spatial resolution features (the General Model computes these spatial features on every image and this requires many more computations).

One advantage of the present invention is that it produces accurate estimates of the MOS, while only requiring the communication of low bandwidth feature information. This makes the method particularly useful for monitoring the end-to-end quality of video distributed over the Internet and wireless video services, which may have limited bandwidth capabilities.

It should be noted that the French company TDF appears to have used the earlier inventions cited above and appears to have applied for at least one patent in France or Europe. U.S. company Tektronics, Incorporated (Beaverton, Oreg.) appears to have utilized the previously cited earlier inventions and has received a U.S. Pat. No. 6,246,435, incorporated herein by reference where the auxiliary communication channel for the features was replaced by a virtual communication channel embedded within the video channel.

The present invention includes modifications to the video calibration procedures that allow for a down-stream only (or up-stream only) system to calibrate video in a very low bandwidth environment, for example 20 kilobits/sec, while retaining field-accurate spatial-temporal registration.

The present invention includes modifications to the model and calibration procedures that allow for accurate calibration and MOS estimation for reduced image resolutions, such as are used by cell phones and PDAs, and increased image resolutions, such as are used by HDTV.

The present invention includes a modified fast-running version, which provides faster calculation of MOS estimation with minimal loss of accuracy.

NTIA reports TR-06-433a, and TR-06-433, before revisions, also describe various aspects of the present invention and are incorporated herein by reference. Reference is also made to NTIA handbook HB-06-434a and TR-06-434, before revisions, both of which are also incorporated herein by reference. The TR-06-433a document describes low bandwidth calibration in more detail. The fast low-bandwidth model approximation is documented as a footnote within the HB-06-434a document.

### BRIEF DESCRIPTION OF THE DRAWINGS

FIG. 1 is a plot of the 9-bit non-linear quantizer used for the ƒ_{SI13} source feature.

FIG. 2 is an example plot of the ƒ_{ATI} feature for a source (solid) and destination (dashed) video scene from a digital video system with transient burst errors in the digital transmission channel.

FIG. 3 is a scatter plot for the subjective data versus the 10 kilobits/second VQM where each data set is shown in a different color.

FIG. 4 is a screen snapshot of the running system.

FIG. 5 is an overview block diagram of one embodiment of the invention and demonstrates how the invention is non-intrusively attached to the input and output ends of a video transmission system.

### DETAILED DESCRIPTION OF THE INVENTION

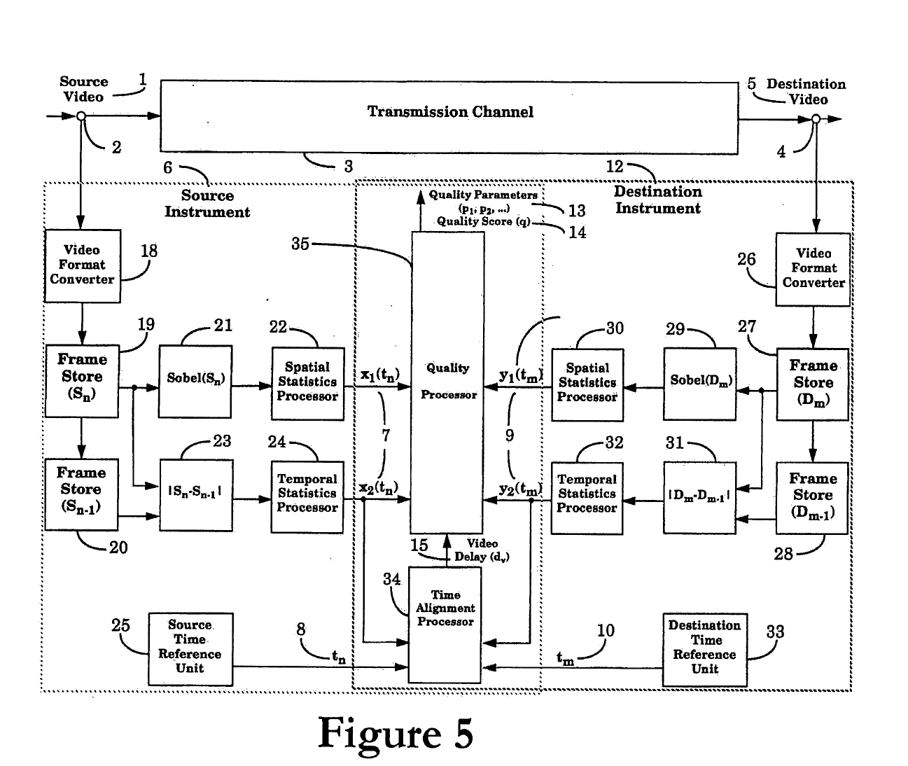

FIG. 5 is a detailed block diagram of a source instrument 6 and destination instrument 12 for measuring the video delay and perceptual degradation in video quality according to one embodiment of the present invention. FIG. 5 is illustrated and described in more detail in U.S. Pat. No. 5,596,364, previously incorporated by reference. The present invention represents an improvement over the apparatus of FIG. 5. However, the diagram of FIG. 5 illustrates the main components of both inventions. In FIG. 5, a non-intrusive coupler 2 is attached to the transmission line carrying the source video signal 1. The output of the coupler 2 is fed to a video format converter 18. The purpose of the video format converter 18 is to translate the source video signal 1 into a format that is suitable for a first source frame store 19.

The first source frame store 19 is shown containing a source video frame Sₙ at time tₙ, as output by the source time reference unit 25. At time tₙ, a second source frame store 20 is shown containing a source video from Sₙ₋₁, which is one video frame earlier in time than that stored in the first source frame store 19. A source Sobel filtering operation is performed on source video frame Sₙ by the source Sobel filter 21 to enhance the edge information in the video image. The enhanced edge information provides an accurate, perception-based measurement of the spatial detail in the source video frame Sₙ. A source absolute frame difference filtering operation is performed on the source video frames Sₙ and Sₙ₋₁ by a source absolute frame difference filter 23 to enhance the motion information in the video image. The enhanced motion information provides an accurate, perception-based measurement of the temporal detail between the source video frames Sₙ and Sₙ₋₁.

A source spatial statistics processor 22 and a source temporal statistics processor 24 extract a set of source features 7 from the resultant images as output by the Sobel filter 21 and the absolute frame difference filter 23, respectively. The statistics processors 22 and 24 compute a set of source features 7 that correlate well with human perception and can be transmitted over a low-bandwidth channel. The bandwidth of the source features 7 is much less than the original bandwidth of the source video 1.

Also in FIG. 5, a non-intrusive coupler 4 is attached to the transmission line carrying the destination video signal 5. Preferably, the coupler 4 is electrically equivalent to the source coupler 2. The output of the coupler 4 is fed to a video format converter 26. The purpose of the video format converter 26 is to translate the destination video signal 5 into a format that is suitable for a first destination frame store 27. Preferably, the video format converter 26 is electrically equivalent to the source video format converter 18.

The first destination frame store 27 is shown containing a destination video frame Dₘ at time tₘ, as output by the destination time reference unit 33. Preferably, the first destination frame store 27 and the destination time reference unit 33 are electrically equivalent to the first source frame store 19 and the source time reference unit 25, respectively. The destination time reference unit 33 and source time reference unit 25 are time synchronized to within one-half of a video frame period.

At time tₘ, the second destination frame store 28 is shown containing a destination video frame Dₘ₋₁, which is on video frame earlier in time than that stored in the first destination frame store 27. Preferably, the second destination frame store 28 is electrically equivalent to the second source frame store 20. Preferably, frame stores 19, 20, 27 and 28 are all electrically equivalent.

A destination Sobel filtering operation is performed on the destination video frame Dₘ by the destination Sobel filter 29 to enhance the edge information in the video image. The enhanced edge information provides an accurate, perception-based measurement of the spatial detail in the source video frame Dₘ. Preferably, the destination Sobel filter 29 is equivalent to the source Sobel filter 21.

A destination absolute frame difference filtering operation is performed on the destination video frames Dₘ and Dₘ₋₁, by a destination absolute frame difference filter 31 to enhance the motion information. The enhanced motion information provides an accurate, perception-based measurement of the temporal detail between the destination video frames Dₘ and Dₘ₋₁. Preferably, the destination absolute frame difference filter 31 is equivalent to the source absolute frame difference filter 23.

A destination spatial statistics processor 30 and a destination temporal statistics processor 32 extract a set of destination feature 9 from the resultant images as output by the destination Sobel filter 29 and the destination absolute frame difference filter 31, respectively. The statistics processors 30 and 32 compute a set of destination features 9 that correlate well with human perception and can be transmitted over a low-bandwidth channel. The bandwidth of the destination features 9 is much less than the original bandwidth of the destination video 5. Preferably, the destination statistics processors 30 and 32 are equivalent to the source statistics processors 22 and 24, respectively.

The source features 7 and destination features 9 are used by the quality processor 35 to compute a set of quality parameters 13 (p₁, p₂, . . . ) and quality score parameter 14 (q). According to one embodiment of the invention, a detailed description of the process used to design the perception-based video quality measurement system will now be given. This design process determines the internal operation of the statistics processors 22, 24, 30, 32 and the quality processor 35, so that the system of the present invention provides human perception-based quality parameters 13 and quality score parameter 14.

The present invention comprises a new reduced reference (RR) video quality monitoring system that utilizes less than 10 kilobits/second of reference information from the source video stream. This new video quality monitoring system utilizes feature extraction techniques similar to those found in the NTIA General Video Quality Model (VQM) that was recently standardized by the American National Standards Institute (ANSI) and the International Telecommunication Union (ITU). Objective to subjective correlation results are presented for 18 subjectively rated data sets that include more than 2500 video clips from a wide range of video scenes and systems. The method is being implemented in a new end-to-end video-quality monitoring tool that utilizes the Internet to communicate the low bandwidth features between the source and destination ends.

To be accurate, digital video quality measurements must measure perceived “picture quality” of the actual video being sent by the end-user (i.e., in-service measurement). Perceived quality of a digital video system is variable and depends upon dynamic characteristics of both the input video scene and the digital transmission channel. A full reference quality measurement system (i.e., a system that has full access to the original source video stream) cannot be used to perform in-service monitoring since the original source video is generally not be available at the destination end. However, a reduced reference (RR) quality measurement system can provide an effective method for performing perception-based in-service measurements. RR systems operate by extracting low bandwidth features from the source video and transmitting these source features to the destination location, where they are used in conjunction with the destination video stream to perform a perception based quality measurement.

The present invention presents a new low bandwidth RR video quality monitoring system that utilizes techniques similar to those of the NTIA General Video Quality Model (VQM), (See, e.g., S. Wolf and M. Pinson, “Video Quality Measurement Techniques,” and M. Pinson and S. Wolf. “A New Standardized Method for Objectively Measuring Video Quality,”, both of which were previously incorporated by reference). The NTIA General VQM was one of the top performing video quality measurement systems in the recent Video Quality Experts Group (VQEG) Full Reference Television (FRTV) phase 2 tests (See, e.g., “Final Report from the Video Quality Experts Group on the Validation of Objective Models of Video Quality Assessment, Phase II,” previously incorporated by reference) and as a result has been standardized by both ANSI (See, e.g., ANSI TI.801-2003, previously incorporated by reference) and the ITU (See, e.g., ITU-T J.144R, and ITU-R BT.1683, both previously incorporated by reference).

While the NTIA General VQM was submitted to the VQEG FRTV tests, this VQM is in fact a high bandwidth RR system. NTIA chose to submit a RR system to the full reference VQEG tests, since research with the best NTIA video quality metrics demonstrated that there was little to be gained by using more than several Megabits/second of reference information [See, e.g., Wolf and M. H. Pinson, “The Relationship Between Performance and Spatial-Temporal Region Size for Reduced-Reference, In-Service Video Quality Monitoring Systems,” previously incorporated by reference), which is the approximate bit-rate of the NTIA General VQM.

This present invention comprises a new RR system that utilizes less than 10 kilobits/second of reference information while still achieving high correlation to subjective quality. Results are presented for 18 subjectively rated data sets that include more than 2500 video clips from a wide range of video scenes and systems. The method is being implemented in a new end-to-end video-quality monitoring tool that utilizes the Internet to communicate the low bandwidth features between the source and destination ends.

The following is an overview of the RR model, including (1) the low bandwidth features that are extracted from the source and destination video streams, (2) the parameters that result from comparing like source and destination feature streams, and (3) the VQM calculation that combines the various parameters, each of which measures a different aspect of video quality. For the sake of brevity, extensive references will be made to prior publications incorporated by reference for technical details.

In one embodiment of the invention, the 10 kilobits/second RR model uses the same ƒ_{SI13}, ƒ_{HV13} and ƒ_{COHER}_{_{—}}_{COLOR} features that are used by the NTIA General VQM. These features are described in detail in sections 4.2.2 and 4.3 of “Video Quality Measurement Techniques,” NTIA Report 02-392, June 2002, previously incorporated by reference. Each feature is extracted from a spatial-temporal (S-T) region size of 32 vertical lines by 32 horizontal pixels by 1 second of time (i.e., 32×32×1 s) whereas the NTIA General VQM used S-T region sizes of 8×8×0.2 s for the ƒ_{SI13}, ƒ_{HV13} features and 8×8×1 frame for the ƒ_{COHER}_{_{—}}_{COLOR} feature. The ƒ_{SI13}, ƒ_{HV13} features measure the amount and angular distribution of spatial gradients in S-T sub-regions of the luminance (Y) image while the ƒ_{COHER}_{_{—}}_{COLOR} feature provides a two-dimensional vector measurement of the amount of blue and red chrominance information (C_{B}, C_{R}) in each S-T region. For video at 30 frames per second (fps), these features achieve a compression ratio of more than 30,000 to 1. In another embodiment of the invention, the filter size that is utilized for the computation of the ƒ_{SI} and ƒ_{HV} spatial resolution features is adaptable (e.g., the present invention may utilize 5×5, 9×9, 21×21 filter sizes in addition to the 13×13 filter size that is used in the General Model). This adaptability depends upon the video image size and viewing distance and enables the present invention to produce more accurate quality estimates for low resolution video systems (e.g., 176×144 pixels as used in cell phones) and high resolution video systems (e.g., 1920×1080 pixels as used in high definition TV, or HDTV). In still another embodiment of the invention, a sequence of images (e.g., 30 images or 1 second of image) is first averaged to produce a single image, and the ƒ_{SI} and ƒ_{HV} spatial resolution features are computed on this single image, saving many computations while only minimally decreasing the accuracy of the video quality estimates.

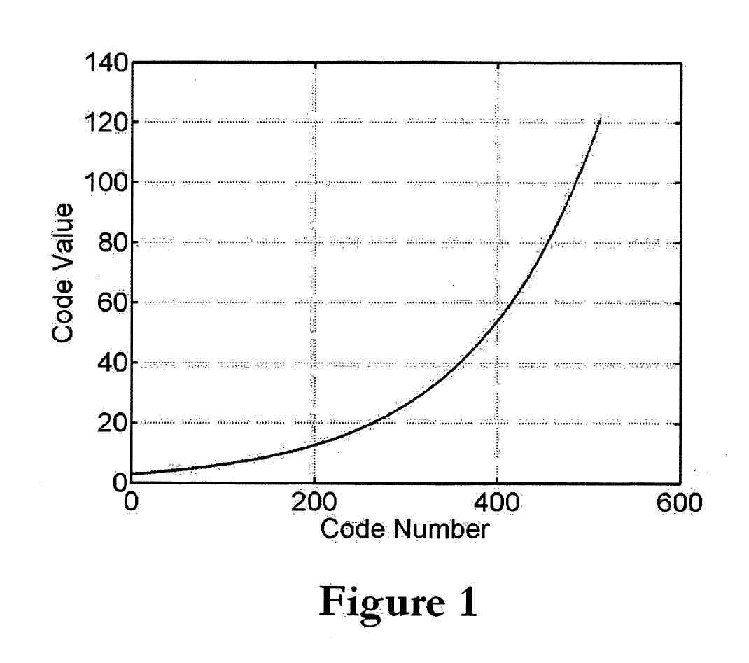

FIG. 1 is a plot of the 9-bit non-linear quantizer used for the ƒ_{SI13} source feature (a similar quantizer design is utilized for the ƒ_{HV13} feature, except that the y-axis code value is matched to the range of the ƒ_{HV13} feature). Quantization to 9 bits of accuracy is sufficient for these features, provided one uses a non-linear quantizer design where the quantizer error is proportional to the magnitude of the signal being quantized. As illustrated in FIG. 1, very low values may be uniformly quantized to some cutoff value, below which there is no useful quality assessment information. Such a quantizer design minimizes the error in the corresponding parameter calculation, which is normally based on an error ratio or log ratio of the destination and source feature streams.

Powerful estimates of perceived video quality can be obtained from the ƒ_{SI13}, ƒ_{HV13} and ƒ_{COHER}_{_{—}}_{COLOR} feature set. However, since the S-T regions from which the above feature statistics are extracted span many video frames (e.g., one second of video frames), they tend to be insensitive to brief temporal disturbances in the picture. Such disturbances can result from noise or digital transmission errors; and, while brief in nature, they can have a significant impact on the perceived picture quality. Thus, a temporal-based RR feature was developed as part of the present invention to quantify the perceptual effects of temporal disturbances. This feature measures the Absolute Temporal Information (ATI), or motion, in all three image planes (Y, C_{B}, C_{R}), and is computed as:
ƒ_{ATI}=rms{YC_{B}C_{R}(t)−YC_{B}C_{R}(t−0.2 s)}

In one embodiment of the invention, the entire three dimensional image at time t−0.2 s is subtracted from the three dimensional image at time t and the root mean square error (rms) of the result is used as a measure of ATI. This feature is sensitive to temporal disturbances in all three image planes: the luminance image (Y), and the blue and red color difference images (C_{B} and C_{R}, respectively). For 30 frames per second (fps) video, 0.2 s is six video frames, while for 25 fps video, 0.2 s is five video frames. Subtracting images 0.2 s apart makes the feature insensitive to real time 30 fps and 25 fps video systems that have frame update rates of at least 5 fps. The quality aspects of these low frame rate video systems, common in multimedia applications, are sufficiently captured by the ƒ_{SI13}, ƒ_{HV13}, and ƒ_{COHER}_{_{—}}_{COLOR} features. The 0.2 s spacing is also more closely matched to the peak temporal response of the human visual system than differencing two images that are one frame apart in time. In another embodiment of the invention, ATI is calculated using a randomly chosen sub-set of pixels rather than the entire image, for increased calculation speed with minimal loss of accuracy. In still another embodiment of the invention, the random sub-set of pixels is only selected from the luminance (Y) image plane.

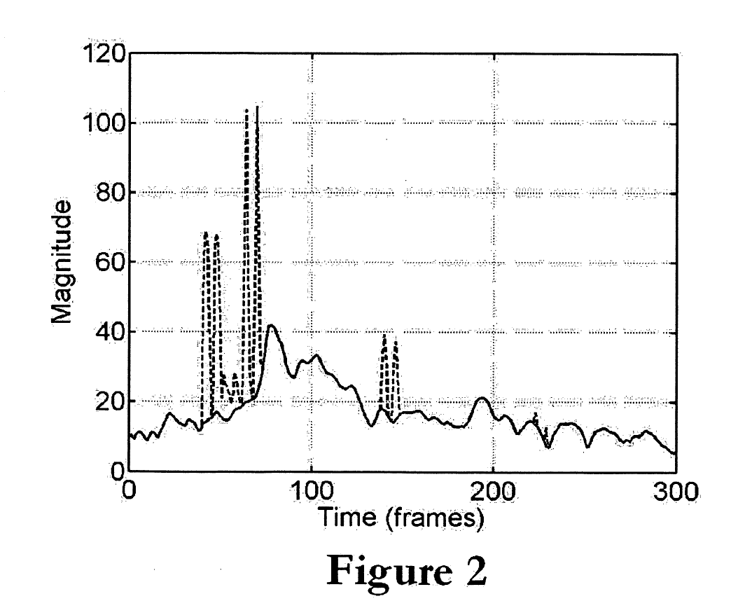

FIG. 2 is an example plot of the ƒ_{ATI} feature for a source (solid) and destination (dashed) video scene from a digital video system with transient burst errors in the digital transmission channel. Transient errors in the destination picture create spikes in the ƒ_{ATI} feature. The bandwidth required to transmit the ƒ_{ATI} feature is extremely low (even using 16 bits/sample) since it requires only 30 samples per second for 30 fps video. The feature can also be used to perform time alignment of the source and destination video streams. Other types of additive noise in the destination video, such as might be generated by an analog video system, will appear as a positive DC shift in the time history of the destination feature stream with respect to the source feature stream. Video coding systems that eliminate noise will cause a negative DC shift.

Several steps are involved in the calculation of parameters that track the various perceptual aspects of video quality. The steps may involve (1) applying a perceptual threshold to the extracted features from each S-T sub-region, (2) calculating an error function between destination features and corresponding source features, and (3) pooling the resultant error over space and time. The reader is directed to section 5 of S. Wolf and M. Pinson, “Video Quality Measurement Techniques,” previously incorporated by reference, for a detailed description of these techniques and their accompanying mathematical notation.

The present invention concentrates on new methods in this area that have been found to improve the objective to subjective correlation beyond what is achievable from the methods found in S. Wolf and M. Pinson, “Video Quality Measurement Techniques,” previously incorporated by reference. It is worth noting that no improvements have been found for the error functions in step 2 (given in section 5.2.1 of S. Wolf and M. Pinson, “Video Quality Measurement Techniques,”). The two error functions that consistently produce the best results are a logarithmic ratio [log 10 (ƒ_destination/ƒ_source)] and an error ratio [(ƒ_destination−ƒ_source)/ƒ_source]. As described in section 5.2 of S. Wolf and M. Pinson, “Video Quality Measurement Techniques,” these errors must be separated into gains and losses, since humans respond differently to additive (e.g., blocking) and subtractive (e.g., blurring) impairments. Applying a lower perceptual threshold to the features (step 1) before application of these two error functions prevents division by zero.

In one embodiment of the present invention one new error pooling method is called macro-block (MB) error pooling. MB error pooling groups a contiguous number of S-T sub-regions and applies an error pooling function to this set. For instance, the function denoted as “MB(3,3,2)max” will perform a max function over parameter values from each group of 18 S-T sub-regions that are stacked 3 vertical by 3 horizontal by 2 temporal. For the 32×32×1 s S-T regions of the ƒ_{SI13}, ƒ_{HV13}, and ƒ_{COHER}_{_{—}}_{COLOR} features described above, each MB(3,3,2) region would encompass a portion of the video stream that spans 96 vertical lines by 96 horizontal pixels by 2 seconds of time. MB error pooling has been found to be useful in tracking the perceptual impact of impairments that are localized in space and time. Such localized impairments often dominate the quality decision process.

A second error pooling method is a generalized Minkowski(P,R) summation, defined as:

$$Minkowski ( P , R ) = \sqrt[R]{\frac{1}{N} {\sum }_{i = 1}^{N} {\vert {v}_{i} \vert}^{P}}$$

Here νᵢ represents the parameter values that are included in the summation. This summation might, for instance, include all parameter values at a given instance in time (spatial pooling), or may be applied to the macro-blocks described above. The Minkowski summation where the power P is equal to the root R has been used by many developers of video quality metrics for error pooling. The generalized Minkowski summation, where P≠R, provides additional flexibility for linearizing the response of individual parameters to changes in perceived quality. This may be a necessary step before combining multiple parameters into a single linear estimate of perceived video quality.

Before extracting a transient error parameter from the ƒ_{ATI} feature streams shown in FIG. 2, it is advantageous to increase the width of the motion spikes (dashed spikes in FIG. 2). The reason is that short motion spikes from transient errors do not adequately represent the perceptual impact of these types of errors. One method for increasing the width of the motion spikes is to apply a maximum filter to both the source and destination feature streams before calculation of the error function between the two waveforms. In one embodiment of the present invention, a seven point wide maximum filter was used, that produces an output sample at each frame that is the maximum of itself and the three nearest neighbors on each side (i.e., earlier and later time samples).

Similar to the NTIA General VQM, the 10 kilobits/second VQM calculation linearly combines two parameters from the ƒ_{HV13} feature (loss and gain), two parameters from the ƒ_{SI13} feature (loss and gain), and two parameters from the ƒ_{COHER}_{_{—}}_{COLOR} feature. The one noise parameter in the NTIA General model has been replaced with two parameters based on the low bandwidth ƒ_{ATI} feature described in the present application; one parameter measures added noise and the other parameter measures temporal disturbances in the destination picture.

For 30 fps video in the 525-line format, a 384-line×672-pixel sub-region centered in the ITU-R Recommendation BT.601 video frame (i.e., 486 line×720 pixel) produces a VQM bit rate before any coding (e.g., Huffman) that is less than 10 kilobits/second. Since Internet connections are ubiquitously available at this bit rate, the new 10 kilobits/second VQM can be used to monitor the end-to-end quality of video transmission between nearly any source and destination location.

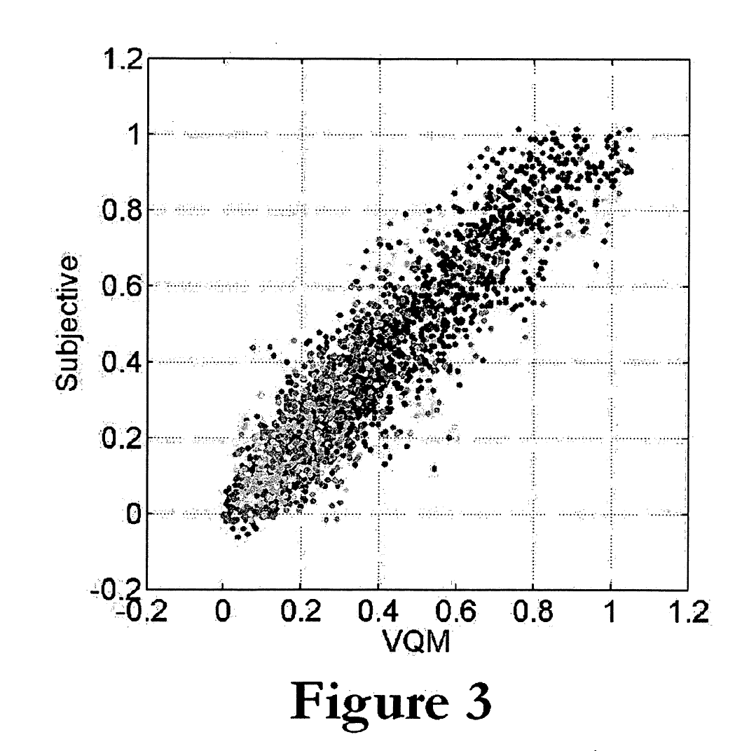

The techniques presented in M. Pinson and S. Wolf, “An Objective Method for Combining Multiple Subjective Data Sets,” previously incorporated by reference, were used together with the NTIA General VQM parameters to map 18 subjective data sets onto a (0, 1) common subjective quality scale, where “0” represents no perceived impairment and “1” represents maximum impairment. With the subjective mapping procedure used, occasional excursions less than 0 (quality improvements) and more than 1 are allowed. The 18 subjectively rated video data sets contained 2651 video clips that spanned an extremely wide range of scenes and video systems. The resulting subjective data set was used to determine the optimal linear combination of the 8 video quality parameters in the 10 kilobits/second VQM previously noted. FIG. 3 is a scatter plot for the subjective data versus the 10 kilobits/second VQM where each data set is shown in a different shade. As illustrated in FIG. 3, there is a substantial correlation between the subjective data and the VQM data, as indicated by the spread of the data points along an axis inclined at 45 degrees. Each data point shows that the subjective value and the VQM value are substantially equivalent for all data sets.

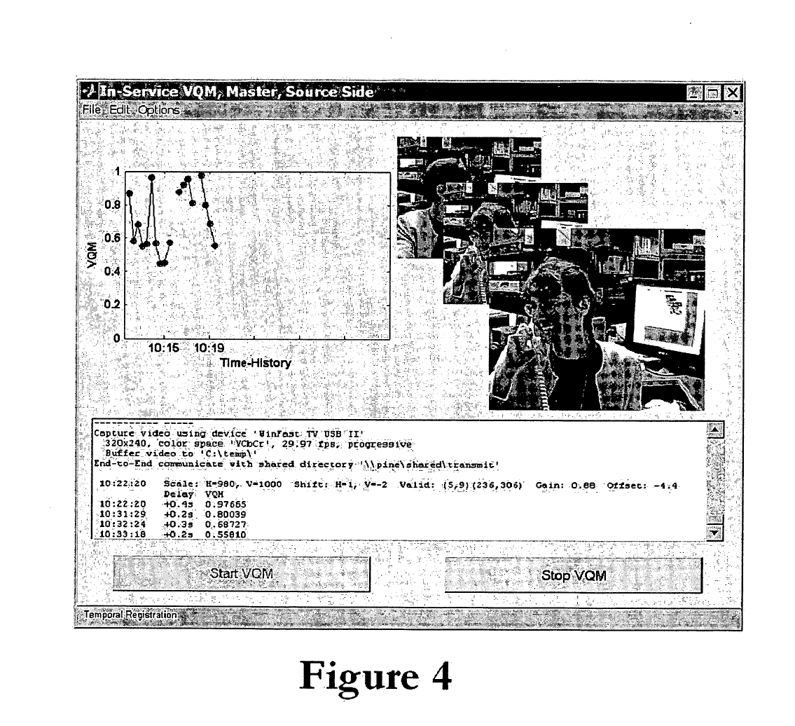

The NTIA General VQM, as well as the new 10 kilobits/second VQM, have been implemented in a new PC-based software system that has been specifically designed to perform continuous in-service monitoring of video quality. FIG. 4 gives a screen snapshot of the running system. The system uses a graphical user interface to provide the user with captured video images as well as VQM measurement information. The reader is directed to the “In Service Video Quality Metric (IVQM) User's Manual”, National Telecommunications and Information Administration (NTIA) Handbook HB-06-434a, July, 2006, previously incorporated by reference, for a detailed description of the PC-based software system that implements the new 10 kilobits/second VQM.

The video quality monitoring system runs on two PCs and communicates the RR features via an Internet connection. The software supports frame-capture devices, including newer USB 2.0 frame capture devices that attach to laptops. The duty cycle of the continuous quality monitoring (i.e., percent of video stream from which video quality measurements are performed) depends upon the CPU speed of the host machine.

Calibration of the system (e.g., spatial scaling/registration, valid video region estimation, gain/level offset, and temporal registration) can be performed at user-defined time intervals. These novel calibration algorithms that require very little feature transmission bandwidth are described in detail in the document entitled “Reduced Reference Video Calibration Algorithms,” National Telecommunications and Information Administration (NTIA) Technical Report TR-06-433a, July, 2006, previously incorporated by reference. The order in computing the calibration quantities is important as prior calculations can be used to increase the speed and accuracy of subsequent calculations. In particular, approximate temporal registration is estimated first using low bandwidth features based on the ATI and the mean of the luminance images. Estimation of an approximate temporal registration to field accuracy (frame accuracy for progressive video) prior to the other calibration algorithms eliminates a computationally costly temporal registration search for the other calibration steps.

Next, spatial scaling and spatial registration is simultaneously estimated using two types of features (i.e., randomly selected pixels and horizontal/vertical image profiles generated from the luminance Y image) that are extracted from a sampled video time segment (of for example 10 seconds). The randomly chosen pixels provide accuracy, and the profiles provide robustness. When used together (pixels and profiles), high accuracy estimates for spatial scaling & spatial registration are achieved using very low bandwidth features. After correcting for spatial scaling and registration, the valid video region is detected by examining the means of columns and rows in the video image. Next, gain and level offset is estimated from the means of source and corresponding destination image blocks that are extracted from the valid video region only. Preferably, the size of the image blocks depend upon the video image size (e.g., 720×486 video should use 46×46 sized blocks while 176×144 video should use 20×20 sized blocks) and the mean block features should be extracted from one frame every second. Optionally, the temporal registration algorithm can be reapplied using the fully calibrated destination video clip to obtain a slightly improved temporal registration estimate.

If spatial scaling, spatial registration, gain, and level offset estimates are available for other processed video sequences that have passed through the same video system (i.e., all video sequences can be considered to have the same calibration numbers, except for temporal registration and valid video region), then calibration results can be filtered across scenes to achieve increased accuracy. Preferably, median filtering across scenes should be used to produce robust estimates for spatial scaling, spatial registration, gain, and level offset of the destination video stream.

The calibration routines are described in more detail in the TR-06-433a document previously incorporated by reference. The algorithm for simultaneously detecting spatial scaling & spatial shift is novel and unique. The present invention produces significant time-savings by estimating temporal registration first, then spatial scaling/shift; then valid region; then gain & level offset; and finally fine-tuning the temporal registration. This ordering of those steps is both novel and unique. All of these algorithms were modified to fit into the RR environment. Some of the novel features of the present invention include:
1. The spatial scaling.
2. Estimation of an approximate temporal registration to field accuracy (frame accuracy for progressive video) prior to other calibration algorithms. This eliminates the temporal registration search even for systems with temporal registration ambiguities without significant loss in accuracy. This was rather a surprise, and constitutes a significant time savings.
3. Calculation of spatial scaling and shift simultaneously using an entire video sequence (of for example 10 seconds) using two types of information (pixels and profiles). The randomly chosen pixels provide accuracy, and the profiles provide robustness. When used together, spatial scaling & spatial registration estimation accuracy is achieved at a low bandwidth.
4. Use of randomly chosen pixels to estimate spatial scaling and shift. The use of a randomized algorithm is non-intuitive, yet more accurate than the use of carefully chosen pixels. A randomized algorithm is used to increase accuracy while reducing bandwidth.
5. On temporal registration, evaluating features for merit and then using all features at once to estimate temporal registration—the previous algorithm used only one feature at a time.
6. On valid video region, utilizing more of the edge of the image for video sequences that are not expected to have overscan, e.g., cell phones and PDAs.
7. On gain & level offset, calculation for an entire video sequence (of for example 10 seconds) using again the overall estimation of temporal registration to eliminate temporal search.

On the fast-running alternative, the key improvements include:
1. Pre-average the video within each one-second slice of frames before calculation of SI and HV features;
2. Calculate ATI on luminance only (instead of color), and
3. Calculate ATI using a randomly chosen sub-set of pixels rather than on the entire image, for increased calculation speed with minimal loss of accuracy.

The new 10 kilobits/second VQM algorithm of the present invention, combined with the new in-service monitoring system, gives end-users and industry a powerful tool for assessing video calibration and quality, while utilizing the limited bandwidth sometimes available over the internet.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A reduced reference video quality monitoring system utilizing less than 10 kilobits/second of reference information from the source video stream, comprising:
means for determining source reference information for the source video stream, the source reference information including ƒ_{SI13}, ƒ_{HV13}, and ƒ_{COHER}_{_{—}}_{COLOR} reference information from the source video stream, and ƒ_{ATI} reference information as a function of Absolute Temporal Information (ATI) in all three image planes (Y, C_{B}, C_{R}), as ƒ_{ATI}=rms{YC_{B}C_{R}(t)−YC_{B}C_{R}(t−0.2 s)} from the source video stream,
means for transmitting source reference information to a destination of the source video stream, and
means for comparing the reference information from the source video stream with reference information from a destination video stream and determining video quality as a function of the relationship between the source reference information and destination reference information and outputting a Mean Opinion Score (MOS) representing relative quality of the destination video stream to the source video stream.

2. The system of claim 1, further comprising:
a non-linear 9-bit quantizer for quantizing source reference information prior to transmitting source reference information to reduce the number of bits required for coding a given feature of the source reference information.

3. The system of claim 1, wherein the means for comparing the source reference information and the destination reference information further comprises:
means for error-pooling for comparing destination reference information with source reference information, including a macro-block error pooling function enabling the comparison to be sensitive to localized spatial-temporal impairments while preserving robustness of the overall video quality estimate.

4. The system of claim 3, wherein the means for error-pooling further comprises generalized Minkowski(P,R) error pooling function defined as:
$$Minkowski ( P , R ) = \sqrt[R]{\frac{1}{N} {\sum }_{i = 1}^{N} {\vert {v}_{i} \vert}^{P}}$$
where νᵢ represents parameter values included in the summation.

5. The system of claim 4, where P does not have to equal R and this produces an improved linear response of the invention's output to Mean Opinion Score (MOS).

6. The system of claim 1, further comprising:
means for estimating spatial scaling and registration in a video system using a combined spatial scaling and registration algorithm based on horizontal and vertical image profiles and randomly selected pixels extracted from the source and destination video streams.

7. A reduced reference video quality monitoring method utilizing less than 10 kilobits/second of reference information from the source video stream, comprising the steps of:
determining source reference information for the source video stream, the source reference information including ƒ_{SI13}, ƒ_{HV13}, and ƒ_{COHER}_{_{—}}_{COLOR} reference information from the source video stream, and ƒ_{ATI} reference information as a function of Absolute Temporal Information (ATI) in all three image planes (Y, C_{B}, C_{R}), as ƒ_{ATI}=rms{YC_{B}C_{R}(t)−YC_{B}C_{R}(t−0.2 s)} from the source video stream
transmitting source reference information to a destination of the source video stream, and
comparing the reference information from the source video stream with reference information from a destination video stream and determining video quality as a function of the relationship between the source reference information and destination reference information and outputting a Mean Opinion Score (MOS) representing relative quality of the destination video stream to the source video stream.

8. The method of claim 7, further comprising the step of:
quantizing, using a non-linear 9-bit quantizer, source reference information prior to transmitting source reference information to reduce the number of bits required for coding a given feature of the source reference information.

9. The method of claim 7, wherein the step of comparing the source reference information and the destination reference information further comprises the step of:
error-pooling for comparing destination reference information with source reference information, including a macro-block error pooling function enabling the comparison to be sensitive to localized spatial-temporal impairments while preserving robustness of the overall video quality estimate.

10. The method of claim 9, wherein the step of error-pooling further comprises generalized Minkowski(P,R) error pooling function defined as:
$$Minkowski ( P , R ) = \sqrt[R]{\frac{1}{N} {\sum }_{i = 1}^{N} {\vert {v}_{i} \vert}^{P}}$$
where νᵢ represents parameter values included in the summation.

11. The method of claim 10, where P does not have to equal R and this produces an improved linear response of the invention's output to Mean Opinion Score (MOS).

12. The method of claim 7, further comprising the step of:
estimating spatial scaling and registration in a video system using a combined spatial scaling and registration algorithm based on horizontal and vertical image profiles and randomly selected pixels extracted from the source and destination video streams.

13. A method of monitoring video calibration comparing a plurality of source video images to a plurality of destination video images, where said video calibration includes one or more of spatial scaling/registration, valid video region estimation, gain/level offset, and temporal registration, at user-defined time intervals, the method comprising the steps of:
estimating approximate temporal registration first using low bandwidth features based on the ATI and the mean of the luminance images,
simultaneously estimating spatial scaling and spatial registration using two types of features (i.e., randomly selected pixels and horizontal/vertical image profiles generated from the luminance Y image) extracted from a sampled video time segment,
detecting a valid video region by examining the means of columns and rows in the video image, and
estimating gain and level offset from the means of source and corresponding destination image blocks extracted from the valid video region only.

14. The method of claim 13, wherein the step simultaneously estimating spatial scaling and spatial registration using two types of features comprises the step of simultaneously estimating spatial scaling and spatial registration using randomly selected pixels and horizontal/vertical image profiles generated from the luminance Y image extracted from a sampled video time segment.

15. The method of claim 13 wherein the step of estimating gain and level offset, the destination image blocks depends upon the video image size and the mean block features are extracted from one frame every second.

16. The method of claim 13 wherein the step of estimating gain and level offset, the temporal registration algorithm is reapplied using a calibrated destination video clip to obtain an improved temporal registration estimate.

17. The method of claim 13, wherein if one or more of spatial scaling, spatial registration, gain, and level offset estimates are available for other processed video, then filtering calibration results across other processed video to achieve increased accuracy.

18. The method of claim 17, further comprising the step of median filtering across scenes to produce estimates for one or more of spatial scaling, spatial registration, gain, and level offset of the destination video.

19. The method of claim 13, further comprising the steps of:
determining source reference information for the source video stream, the source reference information including ƒ_{SI13}, ƒ_{HV13}, and ƒ_{COHER}_{_{—}}_{COLOR} reference information from the source video stream, and ƒ_{ATI} reference information as a function of Absolute Temporal Information (ATI) in all three image planes (Y, C_{B}, C_{R}), as ƒ_{ATI}=rms{YC_{B}C_{R}(t)−YC_{B}C_{R}(t−0.2 s)} from the source video stream,
transmitting source reference information to a destination of the source video stream, and
comparing the reference information from the source video stream with reference information from a destination video stream and determining video quality as a function of the relationship between the source reference information and destination reference information and outputting a Mean Opinion Score (MOS) representing relative quality of the destination video stream to the source video stream.

20. The method of claim 19, further comprising the steps of:
quantizing, in a non-linear 9-bit quantizer, source reference information prior to transmitting source reference information to reduce the number of bits required for coding a given feature of the source reference information.

21. The method of claim 19, wherein the step of comparing the source reference information and the destination reference information further comprises the step of:
error-pooling for comparing destination reference information with source reference information, including a macro-block error pooling function enabling the comparison to be sensitive to localized spatial-temporal impairments while preserving robustness of the overall video quality estimate.

22. The method of claim 21, wherein the step of error-pooling further comprises a generalized Minkowski(P,R) error pooling function defined as:
$$Minkowski ( P , R ) = \sqrt[R]{\frac{1}{N} {\sum }_{i = 1}^{N} {\vert {v}_{i} \vert}^{P}}$$
where νᵢ represents parameter values included in the summation.

23. The method of claim 22, where P does not have to equal R and this produces an improved linear response of the invention's output to Mean Opinion Score (MOS).

24. The method of claim 19, further comprising the step of:
estimating spatial scaling and registration in a video system using a combined spatial scaling and registration algorithm based on horizontal and vertical image profiles and randomly selected pixels extracted from the source and destination video streams.

25. A method for monitoring video quality in a destination image, comprising the steps of:
subtracting an entire three dimensional image at time t−0.2 s from a three dimensional image at time t,
taking the root mean square error (rms) of the result of the subtraction step as a measure of Absolute Temporal Information (ATI).

26. The method of claim 25, wherein the measure of ATI is determined as ƒ_{ATI} reference information as a function of Absolute Temporal Information (ATI) in all three image planes (Y, C_{B}, C_{R}), as:
ƒ_{AIT}=rms{YC_{B}C_{R}(t)−YC_{B}C_{R}(t−0.2 s)}
wherein source image reference information includes ƒ_{SI13}, ƒ_{HV13}, and ƒ_{COHER}_{_{—}}_{COLOR} reference information from the source video stream,

27. A method of monitoring video quality in a destination image, comprising the steps of:
extracting ƒ_{SI13}, ƒ_{HV13} and ƒ_{COHER}_{_{—}}_{COLOR} features a spatial-temporal (S-T) region having a horizontal pixel width, a vertical pixel width and a time dimensions, wherein the ƒ_{SI13}, ƒ_{HV13} features measure amount and angular distribution of spatial gradients in S-T sub-regions of the luminance (Y) image while the ƒ_{COHER} _{_{—}}_{COLOR} feature provides a two-dimensional vector measurement of the amount of blue and red chrominance information (C_{B}, C_{R}) in each S-T region, and
computing the ƒ_{SI} and ƒ_{HV} spatial resolution features using an adaptable filter size based upon video image size and viewing distance, and

28. The method of claim 27, where the filter size is one or more of 5×5, 9×9, and 21×21.

29. A method of monitoring video quality from a source image to a destination image, comprising the steps of:
averaging a sequence of source images to produce a source single image,
computing ƒ_{SI} and ƒ_{HV} spatial resolution features on the source single image,
transmitting the spatial resolution features to a destination location,
averaging a sequence of destination images to produce a destination single image,
computing ƒ_{SI} and ƒ_{HV} spatial resolution features on the destination single image, and
comparing computed spatial resolution features from the source single image with the computed spatial resolution features from the destination single image to monitor video quality in the destination image.

30. The method of claim 29 further comprising the step of calculating an ƒ_{ATI} feature determined as a function of Absolute Temporal Information (ATI) in all three image planes (Y, C_{B}, C_{R}), as:
ƒ_{ATI}=rms{YC_{B}C_{R}(t)−YC_{B}C_{R}(t−0.2 s)}
wherein the ƒ_{ATI} calculation only includes a randomly chosen sub-set of pixels rather than the entire image.
